(19) United States
(12) Patent Application Publication
(10) Pub. No.: US 2023/0202074 A1
(43) Pub. Date: Jun. 29, 2023

(54) SINGLE-ACTING FULL RETURN MOLD CLAMP

(71) Applicant: Durbin Industrial Valve Repair, Inc., Akron, OH (US)

(72) Inventors: Braden Westfall, Massillon, OH (US); Matthew Jeffries, Kent, OH (US); Jason Paquette, North Canton, OH (US)

(21) Appl. No.: 18/079,367

(22) Filed: Dec. 12, 2022

Related U.S. Application Data
(60) Provisional application No. 63/289,327, filed on Dec. 14, 2021.

(51) Int. Cl. B29C 33/24; B29C 41/38

(52) U.S. Cl. CPC B29C 33/24; B29C 41/38

(57) ABSTRACT

A single-acting, full return clamp (10) holds first and second objects, such as mold portions, in a compressive clamping relationship. A body (12), for attachment to the first object, has a housing (22) with first and second end plates (16, 18). A shaft (26) moves axially in the body and rotates about an axis of the body. A shaft end (32) outside of the housing bears against the second object in a first condition and disengages from the second object in a second condition, where the shaft end is lifts away from the body, and rotates relative to the axis. A spring (40) in the housing applies compressive force on the shaft in the first condition. A piston (74), in the housing near the first end plate when the device is in the first condition, moves axially against the spring force to move the shaft while in the second condition.

### CROSS-REFERENCE TO RELATED APPLICATIONS

This application is a non-provisional patent application that makes a priority claim to U.S. provisional application 63/289,327, filed on 14 Dec. 2021.

### TECHNICAL FIELD

The disclosed embodiments relate to a device that normally applies a compressive clamping force, generated by a compressed spring, to engage a first and a second object, such as a pair of mold portions. When actuated, a shaft in a housing of the device extends outwardly from the housing and rotates, disengaging the compressive clamping force. This allows the second object to be removed from the first object, to which the housing is attached. An arm of the shaft, which normally engages the second object into the clamping condition, is disengaged from the second object by the actuation of the device. A particular application is found in the rotational molding of generally hollow parts.

### BACKGROUND

In a number of processes, there is a need to use compressive force to compress at least two mold portions into a clamping position during a molding or curing process. There is also a need to be able to separate and hold the at least two mold portions in a “mold break” position so that a finished part can be removed from an interior of the mold. This type of clamping is used in injection molding, blow molding and the other industrial processes. Clamping is also required in rotational molding or rotational casting, which are related processes in which a charge of finely-divided molding material is formed into a hollow finished product by slowly rotating the mold, usually about two perpendicular axes, while the charge is melted and cooled (rotational molding) or cured (rotational casting) while rotating the mold.

Because the finished product in the rotational process conforms to the shape and size of the mold interior, it is desirable, for ease of removing the part and to charge the mold, to clearly and unobtrusively separate the mold portions.

Especially in rotational molding, the cycles of heating and cooling limit some of the known clamping techniques. In some cases, one or more bolts, especially lug bolts, are used to secure hold the mold portions in the engaged condition. When bolts are used, an impact wrench is usually applied manually to install or remove the bolts.

It is an unmet advantage of the prior art to provide a device for compressively clamping mold portions together during a molding process while allowing the mold portions to be separated by a single actuating action, after which the mold portions are fully returned to the compressive clamping position.

### SUMMARY

This and other unmet advantages are provided by a device for selectively holding a first and a second object in a compressive clamping relationship. Such a device has a body, a shaft, a spring and a piston. The body is arranged for attachment to the first object, and is defined by a housing with a first and a second end plate. The shaft is arranged to move axially in the body and to rotate about an axis thereof. The shaft has a first end that remains in the housing and a second end that remains outside of the housing beyond the second end plate. The second end is adapted to bear against the second object in a first condition of the device and to disengage from the second object in a second condition of the device in which the second end of the shaft is lifted away from the body, and rotated relative to the axis. The spring is disposed in the housing for applying a compressive spring force on the shaft in the first condition to engage the first and second objects in the compressive clamping relationship. The piston is disposed in the housing near the first end plate when the device is in the first condition, and arranged to move axially against the spring force to move the shaft while in the second condition.

In some embodiments, the device further comprises an inlet port that passes through the first end plate for introducing a pressurized motive fluid into the housing below the piston to move the piston against the spring force as long as the motive fluid is present in the housing. Many of these embodiments also comprise a breather element, positioned in an upper portion of the housing to maintain a space above the piston at ambient pressure.

In many embodiments, the spring is a spiral spring.

It is common that the device will further comprise a means for fastening that extends between the first and second end plates to hold the housing in place.

Many embodiments will further comprise an arm, having a proximal end rigidly affixed to the shaft at or near the second end and extending radially away to a distal end that is adapted to bear against the second object in the first condition. It would be preferred in these embodiments for the distal end of the arm to be adapted for adjusting a compressive force applied to the second object when the device is in the first condition. In an especially preferred embodiment, the arm rotates, while in the second condition, about the axis of the shaft in the range of from about 45º to about 135º in a first direction before rotating back in the opposite direction to an initial position of the first condition.

In many embodiments, the first and second end plates are configured for attachment to the first object.

In many embodiments, the motive fluid is exhausted through the inlet port when a source of the motive fluid is removed from the inlet port. It is preferred that the motive fluid is compressed air.

The preferred embodiments have the spring is in a compressed condition when the device is in the first condition and in a further compressed condition when the device is in the second condition.

A further set of objectives are achieved by a device for rotational molding. Such as device has a rotational mold with a first mold portion and a second mold portion, such that each mold portion has a flange that is registrable with a corresponding flange on the other mold portion to form the rotational mold. This device also has at least one clamping device comprising a body, a shaft, a spring and a piston. The body is configured for attachment to the first mold portion, and is defined by a housing with a first and a second end plate. The shaft is arranged to move axially in the body and to rotate about an axis thereof. The shaft has a first end that remains in the housing and a second end that remains outside of the housing beyond the second end plate, the second end adapted to bear against the second mold portion in a first condition of the device and to disengage from the second mold portion in a second condition of the device in which the second end of the shaft is lifted away from the body, and rotated relative to the axis. The spring is disposed in the housing for applying a compressive spring force on the shaft in the first condition to engage the first and second objects in the compressive clamping relationship. The piston is disposed in the housing near the first end plate when the device is in the first condition, and arranged to move axially against the spring force to move the shaft while in the second condition.

In many of these embodiments, each of the at least one clamping devices comprises an inlet port that passes through the first end plate for introducing a pressurized motive fluid into the housing below the piston to move the piston against the spring force as long as the motive fluid is present in the housing; and a breather element, positioned in an upper portion of the housing to maintain a space above the piston at ambient pressure.

It is preferred for the spring to be a spiral spring.

It is preferred for the device to have a means for fastening that extends between the first and second end plates to hold the housing in place.

It is preferred for the device to comprise an arm, having a proximal end rigidly affixed to the shaft at or near the second end and extending radially away to a distal end that is adapted to bear against the second mold portion in the first condition. The distal end of the arm is preferably adapted for adjusting a compressive force applied to the second mold portion when the device is in the first condition. It is also preferred for the arm, while in the second condition, to rotate about the axis of the shaft in the range of from about 45º to about 135º in a first direction before rotating back in the opposite direction to an initial position of the first condition.

Preferably the first and second end plates are configured for attachment to the first mold portion.

### BRIEF DESCRIPTION OF THE DRAWINGS

A better understanding of the disclosed embodiments will be obtained from a reading of the following detailed description and the accompanying drawings wherein identical reference characters refer to identical parts and in which:

FIGS. 1A and 1B are right front perspective views of an embodiment of a mold clamp of the inventive concept, in an engaged mode and in a disengaged mode, respectively;

FIGS. 2A and 2B are “pie cut” right front perspective views, corresponding to the engaged and disengaged modes shown in FIGS. 1A and 1B, respectively;

FIG. 3 shows a piston, a flange-shaped end of the shaft and a spring washer, as used in the mold clamp, in isolation;

FIG. 4 shows the piston engaged with the flange-shaped end;

FIG. 5 shows the spring washer engaged with the parts in FIG. 4;

FIG. 6 shows a pair of mold clamps in the disengaged mode with a mold for rotational molding; and

FIG. 7 shows the FIG. 6 pair of mold clamps in the engaged mode with the rotational mold.

### DETAILED DESCRIPTION OF A PREFERRED EMBODIMENT

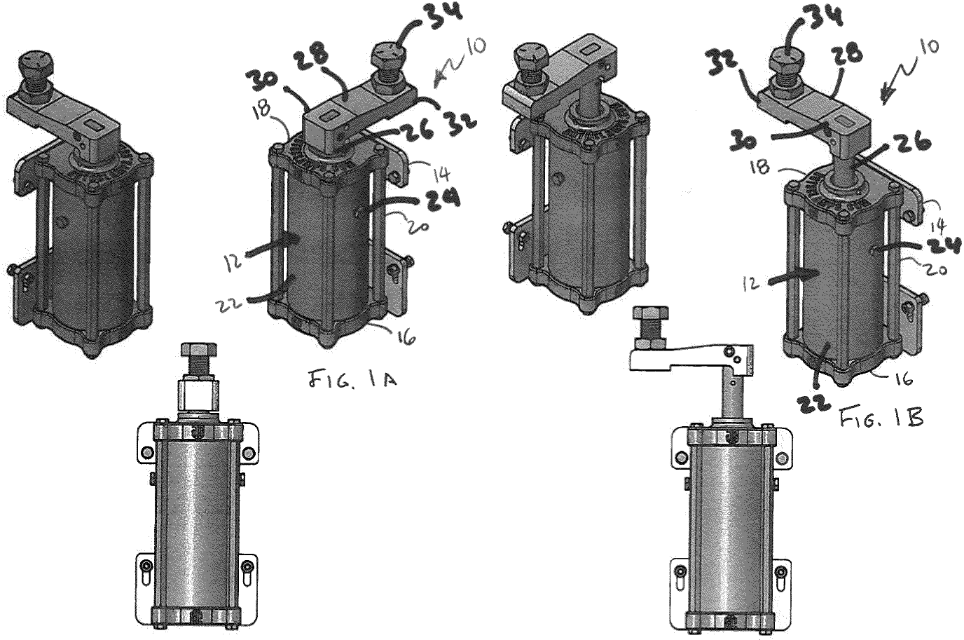

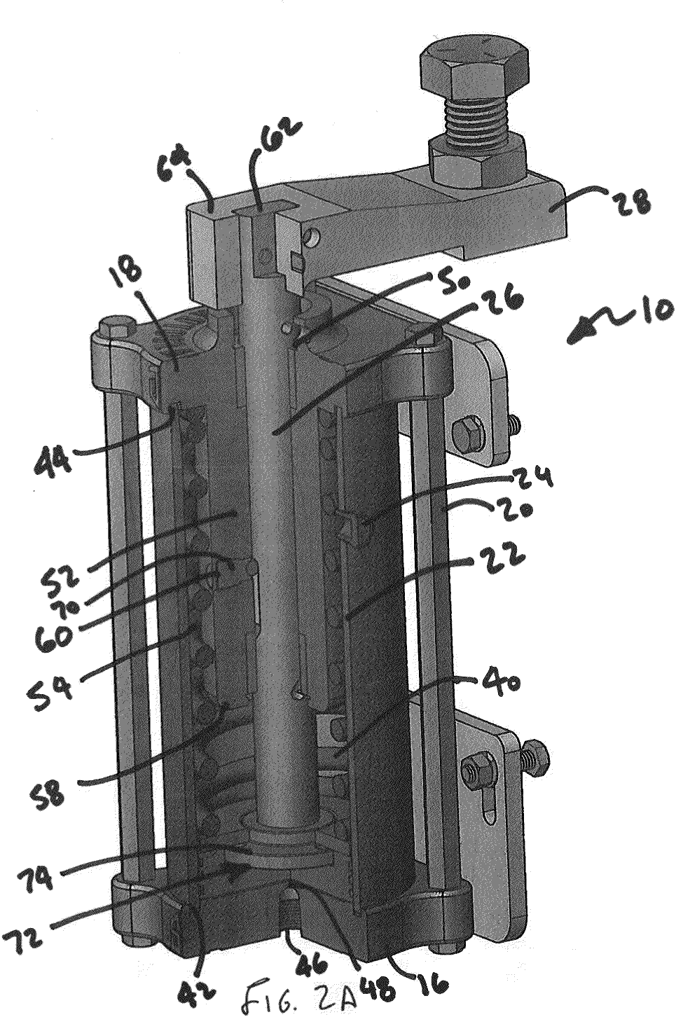

FIGS. 1A and 1B are external, assembled perspective views of an embodiment 10 of a device having the features of the inventive concept. The specific embodiment 10 is shown arranged for use as a mold clamp for holding a first and a second mold portion (not shown) in clamping engagement. FIG. 1A depicts the embodiment 10 in an “engaged” condition in which the mold portions are not only held in registration with each other, but the mold portions are held in that condition under a significant clamping pressure. FIG. 1B depicts the embodiment 10 in a “disengaged” condition in which the mold portions are disengaged, so that a second mold portion may be removed from a first mold portion. This disengagement allows access to an interior of the mold portions, especially the first mold portion. In one very specific application involving the use of the embodiment 10 in rotational molding, the “disengaged” position of embodiment 10 in FIG. 1B permits a charge of a finely divided molding powder to be added to one of the mold portions at the beginning of a mold cycle. The disengaged position of FIG. 1B also permits a part, molded from the molding powder, to be removed from the mold portion. In using the terms “engaged” and “disengaged”, the reference is to whether the respective mold portions are being held together in registration along a joining seam engaged with each other or are disengaged from each other. In another way of referring to the operation of the embodiment 10, the condition of FIG. 1A is a “non-actuated” condition of the embodiment and FIG. 1B shows an “actuated” condition in which the embodiment is actuated, as by a motive fluid, such as compressed air or hydraulic fluid, as will be explained.

Continuing with FIGS. 1A and 1B, the embodiment 10 is seen as having a body 12 with a connection plate 14 attached to the body. Connection plate 14 is the means by which the embodiment 10 would be attached to a first mold portion. The body 12 is elongate, with end plates 16, 18, with end plate 16 operating as a bottom end plate and end plate 18 operating as a top end plate. The respective end plates 16, 18, when viewed from a top or bottom of the embodiment 10, have a generally rectangular, and preferably square, profile. Each corner of end plate 16 is secured in this assembled view to a corresponding corner in end plate 18 by a rod 20, typically solid and threaded on the ends. The rod ends are received in a threaded hole in the end plate 16, 18, or pass through a through hole in the end plate to be secured with a nut. A housing 22 is held in place by the combination of end plates 16, 18 and rods 20. Housing 22 is typically cylindrical and serves to define an axis of symmetry for the embodiment 10. A notable feature on the housing 10 in FIGS. 1A and 1B is a breather element 24 that allows exchange of gas between the interior and exterior of housing 22. This breather element 24 will typically be screwed into a threaded hole in the housing 22 and will be equipped with a filtering means, such as a sintered metal filter. The connection plate 14 that is arranged to be attached to the first mold portion is secured to the body 12 along one of the faces of the body that is defined by the rods 20 and the end plates 16, 18, with the end plates providing good points of attachment. For reference purposes, the connection plate 14 will be considered to be attached to a “rear” face of the body. Close review of FIGS. 1A and 1B will show that no external features of the body 12 move as the embodiment 10 alternates between the engaged and disengaged positions.

The significant changes of the embodiment 10 as it moves from “engaged” to “disengaged”, or vice versa, are seen at a shaft 26 and arm 28 at an upper end, that is, near top end plate 18. What an external observer will see is that shaft 26 is almost fully retracted into the body 12 in the engaged condition of FIG. 1A, with the arm 28 extending radially away from the shaft. Specifically, arm 28 extends from a proximal end 30 that is rigidly affixed to the shaft 26 to a distal end 32 that is characterized by an adjustment means 34, in the nature of a screw. In the engaged position of FIG. 1A, the arm 28 extends out over the rear face of the body 12, that is, so that the distal end 32 is able to compress the second mold portion down against the first mold portion that is attached to connection plate 14. In this manner, arm 28, and especially distal end 32 with adjustment are intended to engage and compress the second mold portion against the first mold portion, holding the registered mold portions together under compressive force.

As seen in FIG. 1B, action occurring inside the body 12 causes the shaft 26 to extend outwardly from the body and also to rotate (as viewed from above) about 90º in the counterclockwise direction to achieve the disengaged condition. The exact extent of both the axial extension and the rotation, as well as the direction of the rotation, are determined by internal features of the embodiment 10, as disclosed below. The amount of compressive force exerted when in the engaged condition is also dependent upon features internal to the embodiment 10. These are adjusted by the exact design of the internal features, but rotation of at least about 90º is probably a minimal amount of rotation of the shaft 26. As also will be explained, the movement from “engaged” to “disengaged” is achieved by applying pressure from a motive fluid to the interior of the body 12. The disengaged condition is maintained by maintaining the applied pressure. When the pressure of the motive fluid is removed, the shaft 26 and arm 28 return smoothly and completely to the FIG. 1A position from the FIG. 1B position. Because the application of pressure (or the removal thereof) causes the full transition from one condition to the other, the embodiment 10 is properly referred to as a “single action full return” rotational mold clamp. The exact sequence of axial extension and rotation of the shaft is determined by features internal to the embodiment 10.

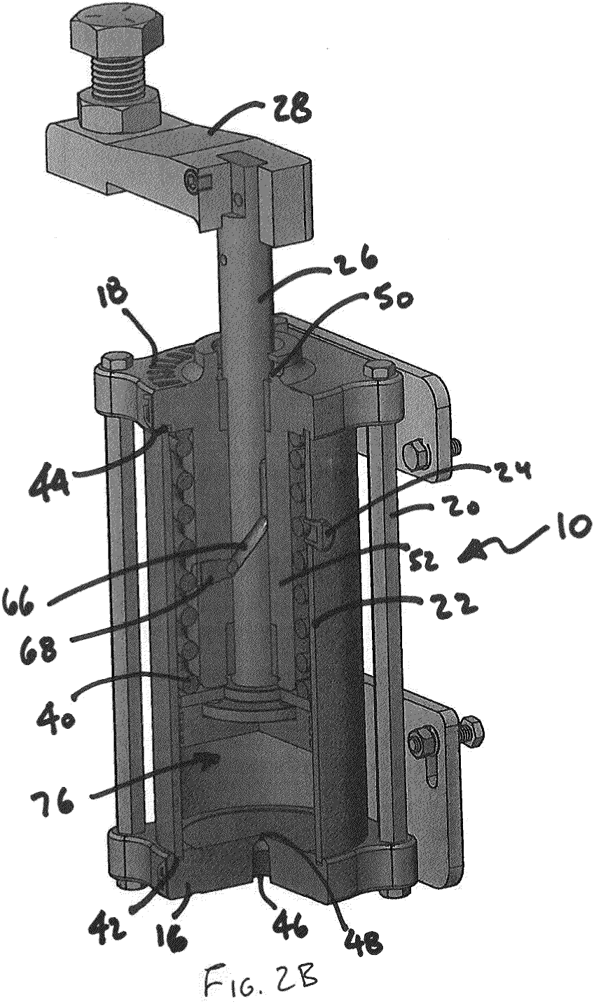

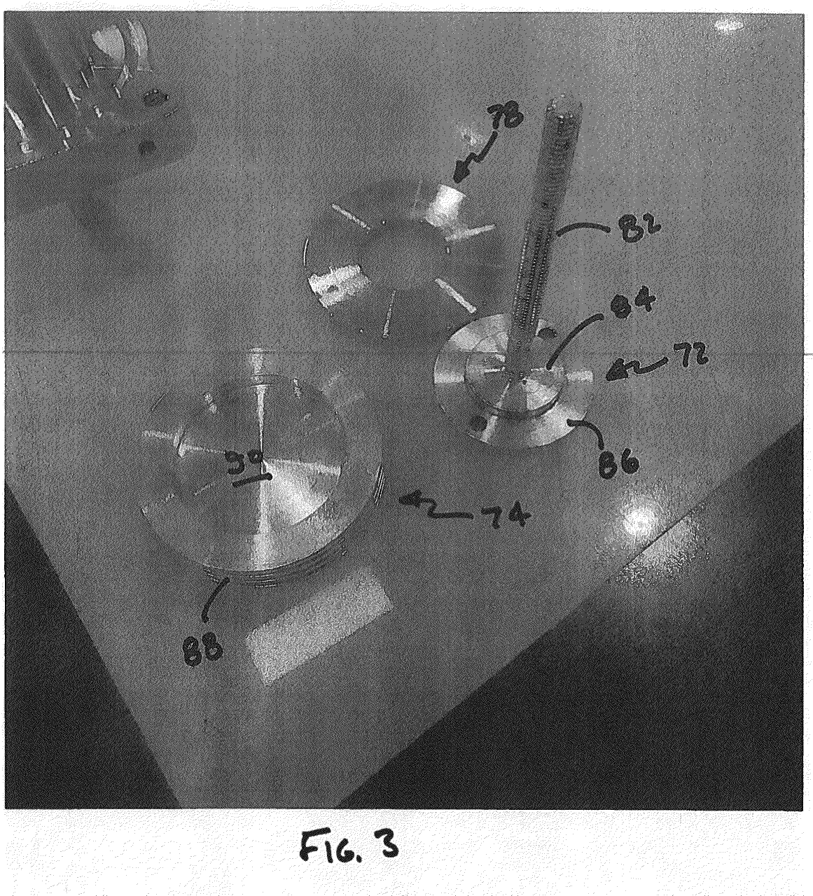

To see these internal features of the embodiment 10, “pie cut” perspective views in FIGS. 2A and 2B reveal the mechanism involved in the inventive concept. The “normally closed” or engaged position of FIG. 2A is primarily effected by the presence of a spiral spring 40 that is held under compression by the body 12.

Some further details of parts from FIG. 1A are seen in FIG. 2A. For example, bottom end plate 16 has a groove 42 formed in it and top end plate 18 has a corresponding groove 44. The grooves 42, 44 are formed on facing surfaces of the respective end plates 16,18 to accept the respective ends of the cylindrical housing 22. Rods 20 and the housing 22 hold the respective end plates 16, 18 in fixed spaced apart relationship when the rod ends are secured, keeping the spring 40 in compression. Not visible in FIG. 1A, an inlet port 46, which may have internal threading, for attachment of a line for supplying pressurized motive fluid is positioned through the bottom end plate 16, preferably along an axis of the shaft 26. It may be preferred, as shown in FIG. 2A, to have an orifice 48 with reduced diameter at the top end of the inlet port 46, as it serves to temper the rate of motive fluid passing through the orifice, which tempers the movement of the shaft 26.

Top end plate 18 also has significant features. A first of these is central opening 50, through which the shaft 26 passes. Another feature is a spindle piece 52 that extends from a bottom side of the top end plate 18 into the interior of the housing 22. Preferably, spindle piece 52 is integrally formed with the top end plate 18, but it could be formed separately and connected to the top end plate, such as by a threaded fitting. The spindle piece 52 has an outside diameter that operates with an inside diameter of the housing 22 to define an annular space 54 in which the spiral spring 40 is confined. The breather element 24 that is positioned in the housing 22 allows the annular space 54 to be maintained at the ambient air pressure during operation of the embodiment 10.

The spindle piece 52 also has an inside diameter that is sized to provide an aligned movement of the shaft 26 within the spindle piece. For that reason, it will be preferred to provide at least one bushing 56 along the inside diameter of the spindle piece and the depicted embodiment shows two such bushings, with one located near each end of the length of the spindle piece 52. Due to its inherent properties, a brass fitting may be preferred for this purpose.

It is also notable that a bottom end 58 of the spindle piece 52 will effectively delimit an amount of axial movement that can be achieved by the shaft 26, and, accordingly, the arm 28, when the embodiment 10 is in the “actuated” condition, as will be seen when reference is made to FIG. 2B. A final feature of the spindle piece 52 is an opening 60 therethrough that houses part of a means for guiding the shaft 26 through axial and rotational movement as the shaft is raised and lowered within the body 12.

Moving to the details of the shaft 26, a first end of the shaft that extends from the body 12 has a shaped end 62 that is complementary to a shaped proximal end 64 of the arm 28, so that rigid attachment of the shaft to the arm is accomplished. In the embodiment 10, the shaped end of the shaft is formed in the nature of a tang, so that it may be passed through the central opening 50 as a part of assembly and a slotted opening is provided in the arm.

A means for defining the axial and rotational movement of the shaft 26 as it moves relative to the body 12 is provided by at least one guide race 66 which co-acts with a guide member 68 that is inserted into the guide race by means of opening 60 in the spindle piece 52. In the depicted embodiment, there are a pair of guide races 66 and a corresponding pair of balls 68 that are sized to fit into the guide races. One example for the guide race 66 would be a groove incised into an outer surface of the shaft 26. During assembly, opening 60 in the spindle piece 52 is aligned with the guide race 66 and the ball 68 is inserted through the opening into the race. The ball 68 is then secured in place by screwing a ball-retaining plug 70 into the opening 60. In a preferred manner of accomplishing this, ball-retaining plug 70 has a cup-shaped end that holds the ball 68 in place relative to the opening 60, but is able to freely rotate in the guide race 66. Since the spindle piece 52 is fixed relative to the body 12, the guide race defines the scope of movement of the shaft 26 relative thereto. In a preferred manner of operating the embodiment 10 during actuation, the guide race 66 is shaped to have the shaft 26 move solely in an axial direction at first until much of the separation is made, and to then rotate about 90º, while still moving axially. As the shaft 26 is withdrawn into the body 12 as the embodiment 10 moves to an “engaged” condition, the shaft first rotates to align the arm 28 with the mold portions and then reduces the axial separation between the arm and the body 12 to allow the clamping action of the spring 40 to occur, engaging the mold portions.

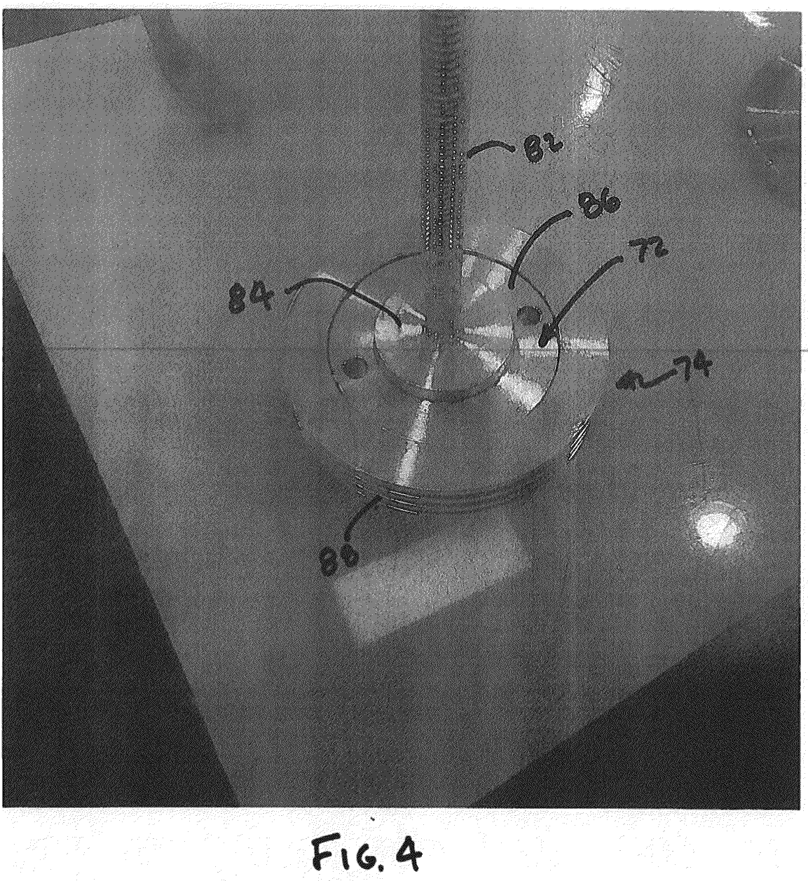

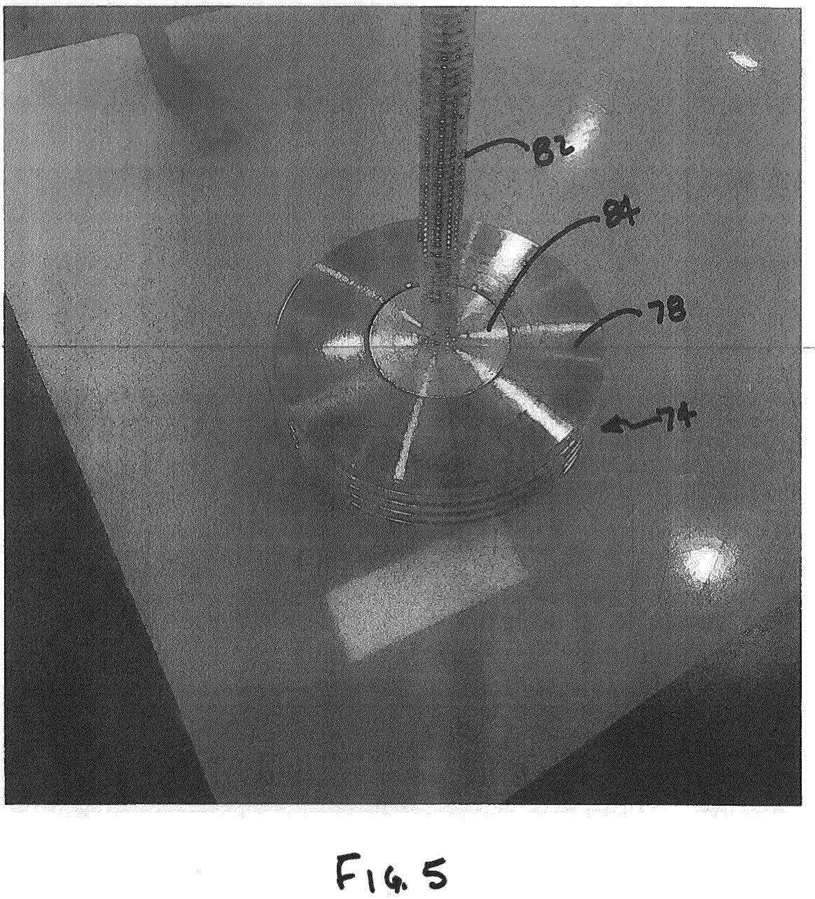

Continuing with details of the shaft 26, attention is now directed to the end thereof that remains in the body 12. In the inventive concept, this end 72 is arranged to allow the shaft 26 to be moved axially into the body 12 by the spring 40 and axially outwardly from the body by a piston 74. The shaft 26 is intended to be able to rotate at least about 90º as it moves in these axial directions, to rotate the arm 28 at the opposite end, but the spring 40 and piston 74 are preferred to move strictly axially, without rotation. Also, it is desired to provide the end 72 with a broadened area on which the spring 40 and piston 74 can act, to distribute forces. For this reason, additional views are provided in FIGS. 3 and 4 to show interacting parts at the shaft end isolated from the overall embodiment 10. Before that, the mode of internal operation of the embodiment 10 should be understood by comparison of the engaged condition show in FIG. 2A and the disengaged condition shown in FIG. 2B. When the mold portions are engaged, as in FIG. 2A, the partially-compressed spring 40 pushes the piston 74 down against the top of the bottom end plate 16. As a motive fluid, such as compressed air, is introduced through inlet port 46, a chamber 76 of the motive fluid forms between the top of the bottom end plate 16 and the piston 74, pushing the piston 74 upwardly, as in FIG. 2B. As this occurs, the air in the annular space 54 is pushed out through the at least one breather element 24. The upward motion of the piston 74 is delimited by at least one of: the bottom of the spindle piece 52, the extent of the guide race 66 and the compressive force of the spring 40 acting against the piston. The piston 74 remains in the raised position seen in FIG. 2B as long as the motive fluid pressure is applied through the inlet port 46. When the pressurized gas source is removed, the compressive force of the spring 40 empties chamber 76 and the piston 74 returns to the FIG. 2A position.

The force exerted by the embodiment 10 to push arm 28 down onto the second object can be adjusted through the adjustment screw 42.

Turning now to FIG. 3, the flange-shaped end 72, piston 74 and the spring washer 78 are each seen in isolation.

Although it is preferred to utilize a ferrous metal, and especially a stainless steel, for the shaft 26, the flange-shaped end 72 is preferred to be a “self-lubricating metal” such as brass. One way to secure such a flange-shaped end 72 to the shaft 26 is to use a threaded rod 82 that screws at one end into the flange-shaped end and at the other end into an axial bore in the shaft. Flange-shaped end 72 is seen as being two integrally-formed flanges 84, 86, with flange 84 having a smaller diameter than flange 86. Flange 86 is depicted with a pair of diametrically-opposed bores which are useful in assembly, but which do not play a role in operation of the device 10. When assembled, flange 84 is positioned nearer to the shaft 26 and flange 86 is positioned nearer to the piston 74.

Interacting with the flange-shaped end 72 is piston 74. As with flange-shape end 72, piston 74 may be preferred to be formed from a “self-lubricating” metal, such as brass. Piston 74 has an outside diameter sized for a close fit inside cylindrical housing 22, and it may be provided with one or more circumferential grooves 88 for accepting a sealing means. When the device 10 is to be used in a rotational molding application, it can be expected to be exposed to temperatures that can be in the range of at least about 400ºF, so a sealing means that is tolerant of high temperatures is very desirable. One example would be a graphite-based sealing means. Of particular importance to the piston design is a carefully-sized cylindrical bore 90 formed in a top of the piston 74. This bore 90 has an inside diameter that is slightly larger than an outside diameter of flange 86, so that a resulting annular gap permits the flange-shaped end 72 to rotate in the bore. The bore 90 also has a depth that slightly exceeds a height of flange 86, so that an axial gap is also provided to allow a slight amount of axial play.

Spring washer 78 is designed to sit atop the piston 74, but it may have a slightly smaller outside diameter, as it plays no role in retaining pressure in chamber 76. That role is provided by piston 74. A preferred metal for the washer 78 may be a ferrous metal, due to the force applied to it by the compressed spring 40. The washer 78 is intended to distribute the forces exerted in opposite axial directions by the spring 40 and the piston 74. The washer 78 also has an inside diameter that is slightly larger than an outside diameter of the smaller flange portion 84. The gap provided by this difference allows the shaft 26 to rotate without interference from washer 78.

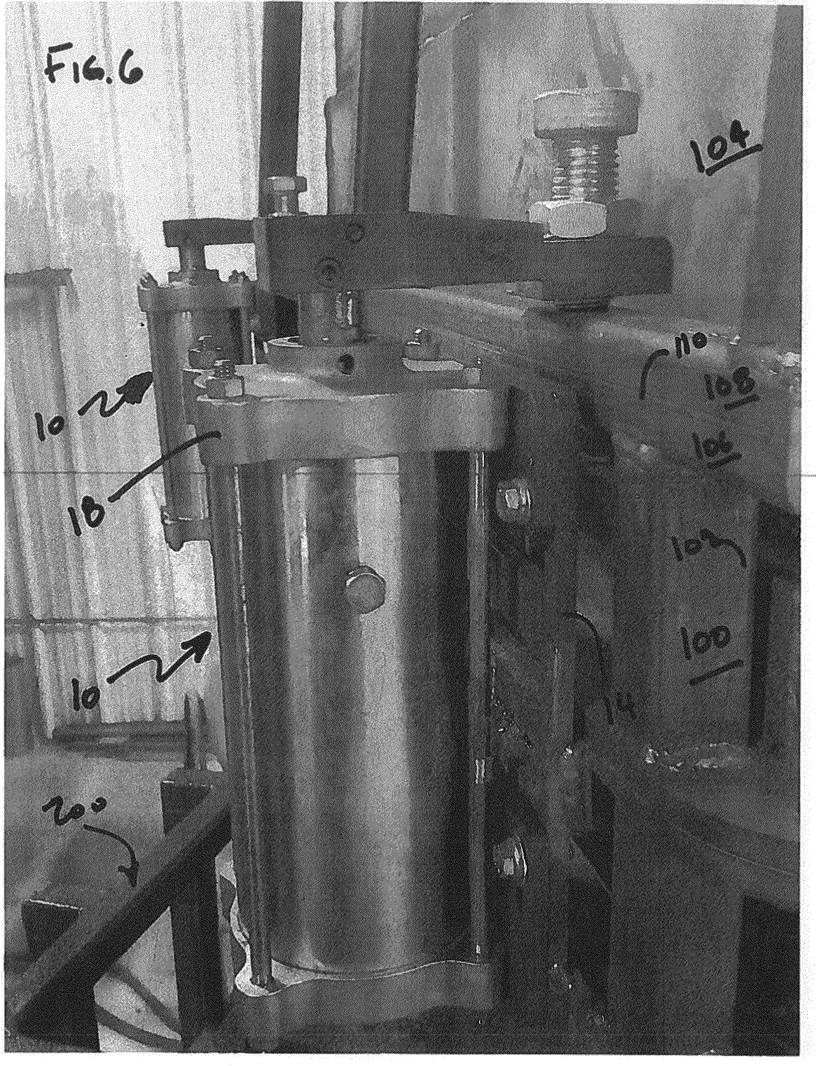

FIG. 4 shows the flange-shaped end 72 positioned in the piston 74, without the spring washer 78. FIG. 5 shows the entire assembly of flange-shaped end 72, piston 74 and washer 78, which is the operational arrangement of these parts. Because of the selected sizes, the piston 74 and the spring washer 78 capture the flange-shaped end 72 for axial movement, but allow the flange-shaped end to rotate in order for the shaft to follow the pattern set out by the guide race.

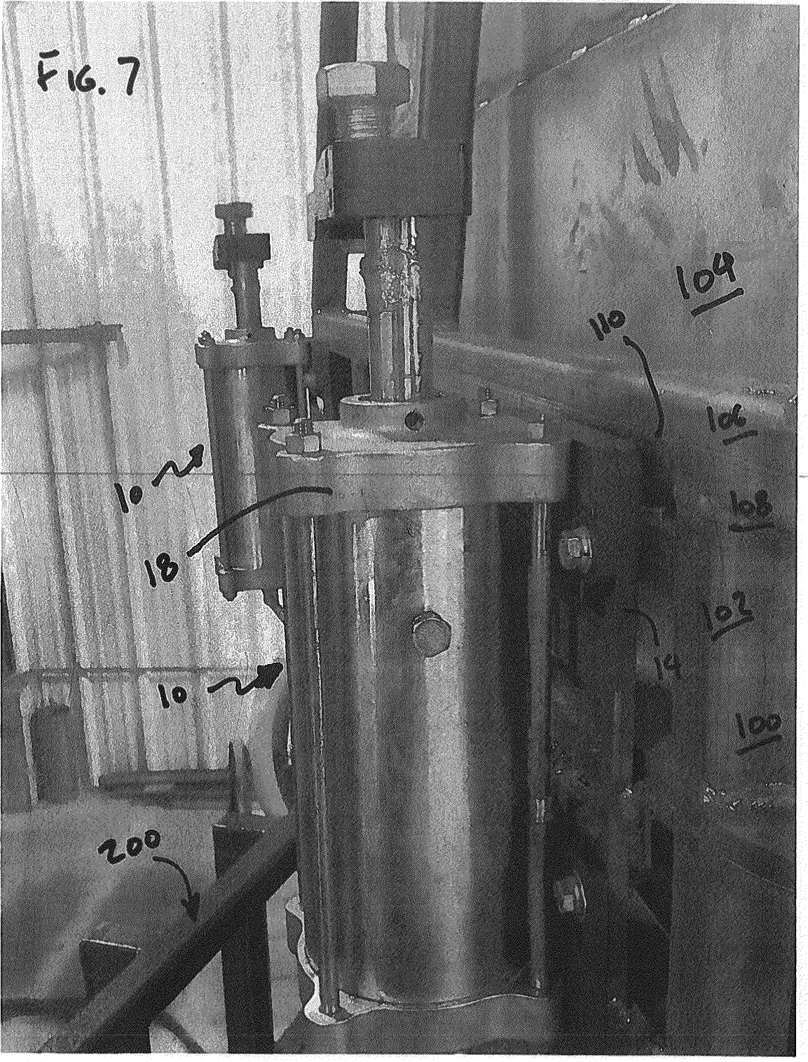

FIGS. 6 and 7 illustrate an application of a clamp 10 of the inventive concept, specifically, selectively engaging and disengaging the first and second mold portions 102, 104 of a rotational mold 100. In FIG. 6, the two clamps 10 engage the mold portions 102, 104 under compressive force; in FIG. 7, the two clamps are disengaged, so that the second mold portion 104 may be removed from the first mold portion 102. In this disengaged status, the second mold portion may be lifted away, allowing access to the interior of the mold 100. Notable on the mold 100 is a flange on each of the mold portions, so that flange 106 of first mold portion 102 can be registered with flange 108 of the second mold portion 104. In the known prior art, these flanges 106, 108 are secured by means such as lug bolts. Between flanges 106 and 108, the parting line 110 of the mold 100 is visible. By positioning connection plate 14 of the clamp 10 in association with the first mold portion 102, the top end plate 18 of the clamp may be positioned at roughly the same height as parting line 110. Also visible in FIGS. 6 and 7 is a framework 200, sometimes referred to as a “spider”, that attaches first mold portion 102 to a device that rotates the assembled mold 100 on two axes, into and out of heating and cooling zones, thereby conducting rotational molding in the mold.

Having shown and described a preferred embodiment of the invention, those skilled in the art will realize that many variations and modifications may be made to affect the described invention and still be within the scope of the claimed invention. Thus, many of the elements indicated above may be altered or replaced by different elements which will provide the same result and fall within the spirit of the claimed invention. It is the intention, therefore, to limit the invention only as indicated by the scope of the claims.

REFERENCE NUMBERS

| | |
|---|---|
| 10 | mold clamp embodiment |
| 12 | body |
| 14 | connection plate |
| 16 | bottom end plate |
| 18 | top end plate |
| 20 | rod |
| 22 | housing |
| 24 | breather element |
| 26 | shaft |
| 28 | arm |
| 30 | proximal end |
| 32 | distal end |
| 34 | adjustment screw |
| 40 | spiral spring |
| 42 | groove in bottom end plate |
| 44 | groove in top end plate |
| 46 | inlet port |
| 48 | reduced diameter orifice |
| 50 | central opening of the top end plate |
| 52 | spindle piece |
| 54 | annular space between housing and spindle piece |
| 56 | bushing |
| 58 | bottom end of spindle piece |
| 60 | opening for guide means |
| 62 | shaped end in nature of a tang |
| 64 | complementarily shaped opening in arm |
| 66 | guide race |
| 68 | ball |
| 70 | ball-retaining plug |
| 72 | flange-shaped end |
| 74 | piston |
| 76 | pressurized gas chamber |
| 78 | spring washer |
| 82 | threaded rod |
| 84 | smaller flange portion |
| 86 | larger flange portion |
| 88 | circumferential grooves |
| 90 | cylindrical bore |
| 100 | rotational mold |
| 102 | first mold portion |
| 104 | second mold portion |
| 106 | flange of first mold portion |
| 108 | flange of second mold portion |
| 110 | parting line |
| 200 | framework or spider |

What is claimed is:

1. A device for selectively holding a first and a second object in a compressive clamping relationship, comprising:
a body, arranged for attachment to the first object, the body defined by a housing with a first and a second end plate;
a shaft, arranged to move axially in the body and to rotate about an axis thereof, the shaft having a first end that remains in the housing and a second end that remains outside of the housing beyond the second end plate, the second end adapted to bear against the second object in a first condition of the device and to disengage from the second object in a second condition of the device in which the second end of the shaft is lifted away from the body, and rotated relative to the axis;
a spring, disposed in the housing for applying a compressive spring force on the shaft in the first condition to engage the first and second objects in the compressive clamping relationship; and
a piston, disposed in the housing near the first end plate when the device is in the first condition, and arranged to move axially against the spring force to move the shaft while in the second condition.

2. The device of claim 1, further comprising:
an inlet port, passing through the first end plate for introducing a pressurized motive fluid into the housing below the piston to move the piston against the spring force as long as the motive fluid is present in the housing; and
a breather element, positioned in an upper portion of the housing to maintain a space above the piston at ambient pressure.

3. The device of claim 1, wherein the spring is a spiral spring.

4. The device of claim 1, further comprising:
a means for fastening, extending between the first and second end plates to hold the housing in place.

5. The device of claim 1, further comprising:
an arm, having a proximal end rigidly affixed to the shaft at or near the second end and extending radially away to a distal end that is adapted to bear against the second object in the first condition.

6. The device of claim 5, wherein:
the distal end of the arm is adapted for adjusting a compressive force applied to the second object when the device is in the first condition.

7. The device of claim 4, wherein:
while in the second condition, the arm rotates about the axis of the shaft in the range of from about 45º to about 135º in a first direction before rotating back in the opposite direction to an initial position of the first condition.

8. The device of claim 1, wherein:
the first and second end plates are configured for attachment to the first object.

9. The device of claim 2, wherein the motive fluid is exhausted through the inlet port when a source of the motive fluid is removed from the inlet port.

10. The device of claim 9, wherein the motive fluid is compressed air.

11. The device of claim 1, wherein the spring is in a compressed condition when the device is in the first condition and in a further compressed condition when the device is in the second condition.

12. A device for rotational molding, comprising:
a rotational mold having a first mold portion and a second mold portion, such that each mold portion has a flange that is registrable with a corresponding flange on the other mold portion to form the rotational mold; and
at least one clamping device, comprising:
a body, configured for attachment to the first mold portion, the body defined by a housing with a first and a second end plate;
a shaft, arranged to move axially in the body and to rotate about an axis thereof, the shaft having a first end that remains in the housing and a second end that remains outside of the housing beyond the second end plate, the second end adapted to bear against the second mold portion in a first condition of the device and to disengage from the second mold portion in a second condition of the device in which the second end of the shaft is lifted away from the body, and rotated relative to the axis;
a spring, disposed in the housing for applying a compressive spring force on the shaft in the first condition to engage the first and second objects in the compressive clamping relationship; and
a piston, disposed in the housing near the first end plate when the device is in the first condition, and arranged to move axially against the spring force to move the shaft while in the second condition.

13. The device of claim 12, wherein each of the at least one clamping devices comprise:
an inlet port, passing through the first end plate for introducing a pressurized motive fluid into the housing below the piston to move the piston against the spring force as long as the motive fluid is present in the housing; and
a breather element, positioned in an upper portion of the housing to maintain a space above the piston at ambient pressure.

14. The device of claim 12, wherein the spring is a spiral spring.

15. The device of claim 12, further comprising:
a means for fastening, extending between the first and second end plates to hold the housing in place.

16. The device of claim 12, further comprising:
an arm, having a proximal end rigidly affixed to the shaft at or near the second end and extending radially away to a distal end that is adapted to bear against the second mold portion in the first condition.

17. The device of claim 16, wherein:
the distal end of the arm is adapted for adjusting a compressive force applied to the second mold portion when the device is in the first condition.

18. The device of claim 16, wherein:
while in the second condition, the arm rotates about the axis of the shaft in the range of from about 45º to about 135º in a first direction before rotating back in the opposite direction to an initial position of the first condition.

19. The device of claim 15, wherein:
the first and second end plates are configured for attachment to the first mold portion.
